(19) United States
(12) Patent Application Publication
(10) Pub. No.: US 2010/0090469 A1
(43) Pub. Date: Apr. 15, 2010

(54) Power-Generator Fan Apparatus, Duct Assembly, Building Construction, and Methods of Use

(76) Inventor: Shaun E. Sullivan, Salem, OR (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/249,776

(22) Filed: Oct. 10, 2008

(51) Int. Cl. F03D 9/00; F24F 7/007; F24F 7/00; F04D 29/34; F03B 17/04

(52) U.S. Cl. 290/55; 454/186; 236/49.3; 416/219 R; 415/916

(57) ABSTRACT

The invention provides a rotatable fan assembly adapted for being connected to a generator that produces electric power in response to rotation of the fan assembly. The fan assembly can be mounted inside an HVAC duct of a building, or used in various other environments.

### FIELD OF THE INVENTION

The invention relates generally to fan assemblies for generating power from a fluid flow. More particularly, the invention relates to fan assemblies for generating power from a gas flow.

### BACKGROUND OF THE INVENTION

A variety of wind turbines are known. Some require complicated systems for adjusting the angles of attack of the turbine blades. Others are very loud when operated. And some are lacking in durability. Moreover, conventional wind turbines may be restrictive of the airflow driving them. The present invention provides a fan assembly designed to address these and other problems associated with conventional wind turbines.

Wind turbines are sometimes positioned on the tops of tall buildings, with the idea that wind at that level will be moving faster than wind near the ground. The average wind speed on the top of a given building may be on the order of 9 miles per hour. By comparison, the air speed inside the main HVAC ducts of a building may be on the order of 1,000-5,000 feet per minute (about 11-57 miles per hour). High-performance HVAC systems may accelerate air to even higher speeds. Some embodiments of the present invention provide buildings, duct assemblies, and methods wherein power is generated using a fan assembly that rotates in response the flow of air through one or more ducts.

### SUMMARY OF THE INVENTION

Some embodiments of the invention provide a building having an HVAC system comprising a blower adapted to move air through a duct of the HVAC system. In the present embodiments, the building has a rotatable fan assembly mounted inside the duct. Preferably, the fan assembly is located such that air moved by the blower flows past the fan assembly, thereby rotating the fan assembly, and then continues on to be distributed inside the building. The fan assembly is operably coupled with a power generator.

In certain embodiments, the invention provides an HVAC duct assembly comprising a blower, a duct, and a rotatable fan assembly. The rotatable fan assembly is mounted inside the duct. The blower is adapted to move air through the duct and past the fan assembly so as to rotate the fan assembly in the process of moving air through the duct.

In some embodiments, the invention provides a method for heating, ventilating, and/or air conditioning a building. The method comprises providing a duct assembly including a blower, a duct, and a rotatable fan assembly. The rotatable fan assembly is mounted inside the duct. The blower is operated so as to move air past the fan assembly, thereby rotating the fan assembly, and then on to be distributed inside the building. The fan assembly is operably coupled with a power generator such that the generator produces electric power in response to rotation of the fan assembly.

Some embodiments of the invention provide a fan assembly adapted to rotate in response to an airflow. The fan assembly has blades that are at least generally parallel to an axis of rotation of the fan assembly. In the present embodiments, each of a plurality of the blades has an angle of attack that is adjustable, and the fan assembly includes a motor adapted to simultaneously adjust the angle of attack of all the blades of this plurality. Preferably, the fan assembly is configured such that the blades of the plurality all occupy substantially the same angle of attack during rotation of the fan assembly. The fan assembly is operably coupled with a power generator adapted to generate electric power in response to rotation of the fan assembly.

In certain embodiments, the invention provides a method of generating electric power. The method involves providing a fan assembly that rotates in response to an airflow. The fan assembly has blades that are at least generally parallel to an axis of rotation of the fan assembly. In the present embodiments, each of a plurality of the blades has an angle of attack that is adjustable, and the fan assembly includes a motor adapted to simultaneously adjust the angle of attack of all the blades of said plurality. Preferably, the method involves the fan assembly rotating in response to the airflow such that the blades of the plurality all occupy substantially the same angle of attack during the rotation of the fan assembly. The fan assembly is operably coupled with a power generator that generates electric power in response to the rotation of the fan assembly.

### BRIEF DESCRIPTION OF THE DRAWINGS

FIG. 1 is a perspective view of a fan assembly mounted on two supports in accordance with certain embodiments of the present invention;

FIG. 2 is a front view of the mounted fan assembly of FIG. 1;

FIG. 3 is a side view of the mounted fan assembly of FIG. 1;

FIG. 4 is a perspective view of a duct assembly having a duct in which a fan assembly is mounted in accordance with certain embodiments of the invention;

FIG. 5 is a side view of a fan assembly mounted on two supports in accordance with certain embodiments of the invention;

FIG. 6 is a cross-sectional view, taken along lines A-A, of the fan assembly of FIG. 5;

FIG. 7 is a broken-away front view of a fan assembly mounted on two supports in accordance with certain embodiments of the invention;

FIG. 8 is a cross-sectional view, taken along lines E-E, of the fan assembly of FIG. 7;

FIG. 9 is a cross-sectional view, taken along lines C-C, of the fan assembly of FIG. 7;

FIG. 10 is a cross-sectional view, along lines D-D, of the fan assembly of FIG. 7;

FIG. 11 is a cross-sectional view, along lines F-F, of the fan assembly of FIG. 7;

FIG. 12 is a schematic side view of a building equipped with duct assemblies that include power-generator fan assemblies in accordance with certain embodiments;

FIG. 13 is a perspective view of a fan assembly in accordance with certain embodiments of the invention;

FIG. 14A is a perspective view of a blade for a fan assembly in accordance with certain embodiments of the invention;

FIG. 14B is another perspective view of the blade of FIG. 14A;

FIG. 14C is still another perspective view of the blade of FIG. 14A;

FIG. 14D is yet another perspective view of the blade of FIG. 14A;

FIG. 15 is a perspective view of a duct assembly having a blower, a duct, and a fan assembly in accordance with certain embodiments of the invention;

FIG. 16 is a perspective view of a duct assembly having a duct in which a fan assembly is mounted in accordance with certain embodiments of the invention;

FIG. 17 is an end view of the duct assembly of FIG. 16; and

FIG. 18 is a broken-away perspective view detailing a power generator in FIG. 16.

### DETAILED DESCRIPTION OF PREFERRED EMBODIMENTS

The following detailed description is to be read with reference to the drawings, in which like elements in different drawings have like reference numbers. The drawings, which are not necessarily to scale, depict selected embodiments and are not intended to limit the scope of the invention. Skilled artisans will recognize that the given examples have many alternatives that fall within the scope of the invention.

The invention provides a fan assembly that is adapted to rotate in response to an airflow. The airflow can be of any type: natural or artificial (e.g., forced). In some cases, the fan is used as an open-air fan, such that the fan rotates in response to natural wind. In other cases, the fan is used in a forced-air environment, such as where a blower rotates the fan. Thus, the fan assembly can be used in a wide variety of environments.

Preferably, the fan assembly is non-restrictive (i.e., is a non-restriction to air flow). In such cases, the fan assembly can be used to generate electric power without restricting an airflow in which the fan is placed. For example, the speed of airflow immediately after the fan assembly preferably is at least equal to the speed of airflow immediately before the fan assembly. In some cases, the fan assembly may actually increase the speed of air flowing across the fan, e.g., such that the speed of the airflow immediately after the fan assembly is greater than the speed of the airflow immediately before the fan assembly.

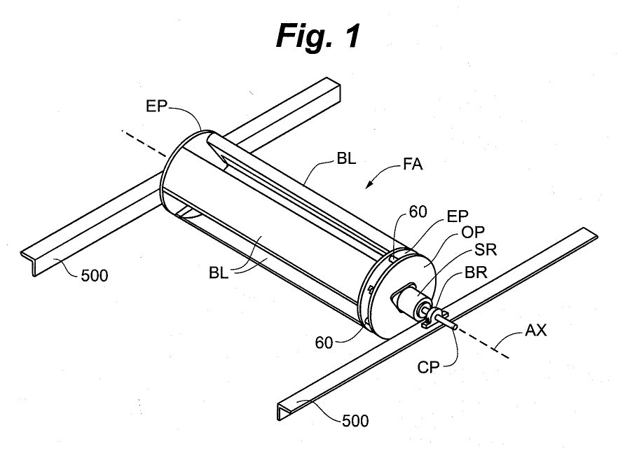

The illustrated fan assembly FA has a generally cylindrical configuration. This is perhaps best appreciated in FIG. 1. Preferably, the fan assembly FA has a plurality of blades (or “wings”) BL. In embodiments like those exemplified in FIG. 1, the blades BL are at least generally (or at least substantially) parallel to the fan assembly's axis of rotation AX (e.g., the longitudinal axis of each blade is parallel to the fan assembly's axis of rotation). The illustrated blades BL are spaced-apart about a perimeter (e.g., a circumference) of the fan assembly FA, so as to generally surround (or “encompass”) the fan assembly's axis of rotation.

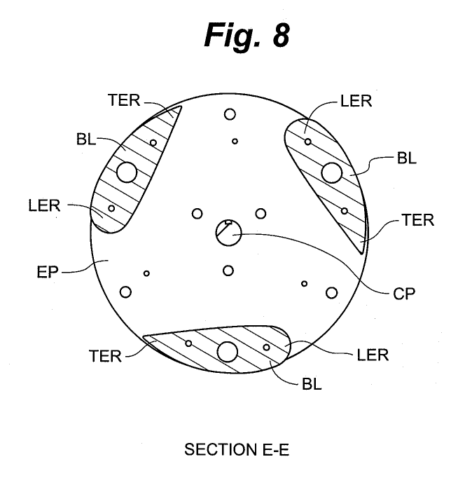

The illustrated fan assembly FA has three blades. This is best seen in FIG. 8. The number of blades, however, can be varied to meet the requirements of different applications.

In some embodiments, the fan assembly FA has two end plates EP, and the blades BL extend between those end plates. However, this is not required in all embodiments. For example, the blades can be held in position by mounting structures other than end plates.

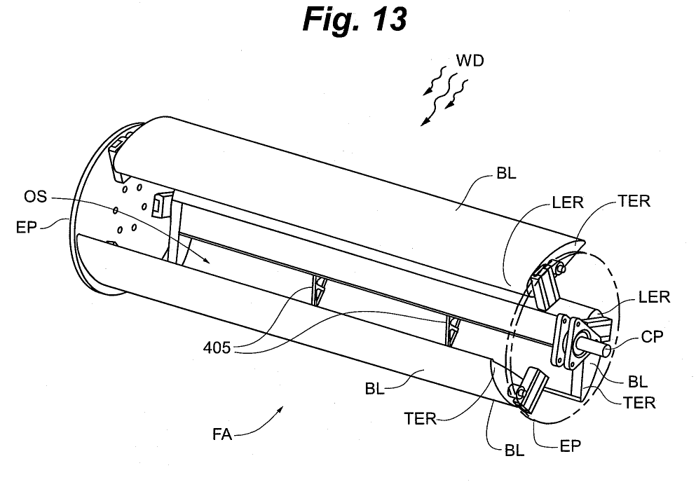

Preferably, the fan assembly FA is adapted to maintain the blades BL at different orientations (e.g., at different angles of attack, or “feathering angles”). This is perhaps best appreciated by comparing the orientation of the blades in FIG. 1 to the orientation of the blades in FIG. 13. The trailing end regions TER of the blades BL in FIG. 13 have been angled (or “feathered”) outwardly. More will be said later about the mechanisms for, and advantages of, feathering the blades BL of the fan assembly FA.

The terms “angle of attack” and “feathering angle” are used herein to refer to the angle of the blades relative to the end plates (not relative to the direction of the airflow incident to the fan assembly).

Preferably, each blade BL has a leading end region LER and a trailing end region TER. The illustrated leading end region LER is a thick edge region and the trailing end region TER is a thin edge region. That is, the leading end region LER is thicker than the trailing end region TER. The configuration of the blade, however, can take the form of many different wing types.

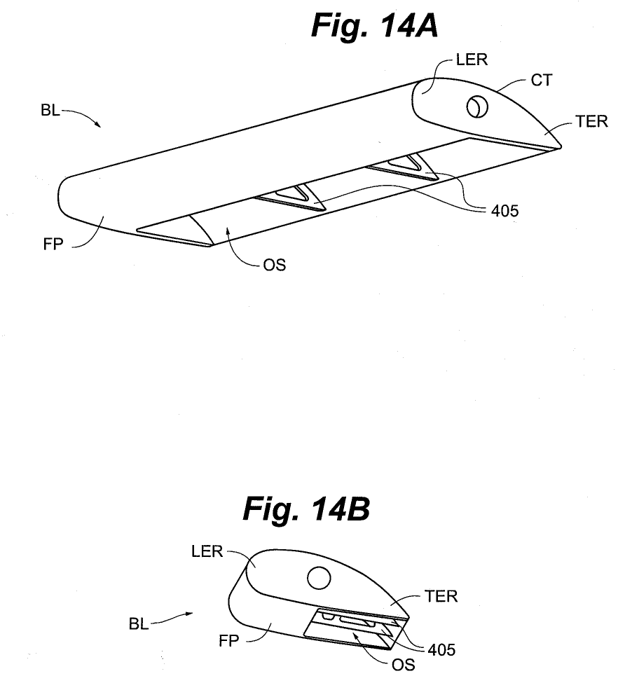

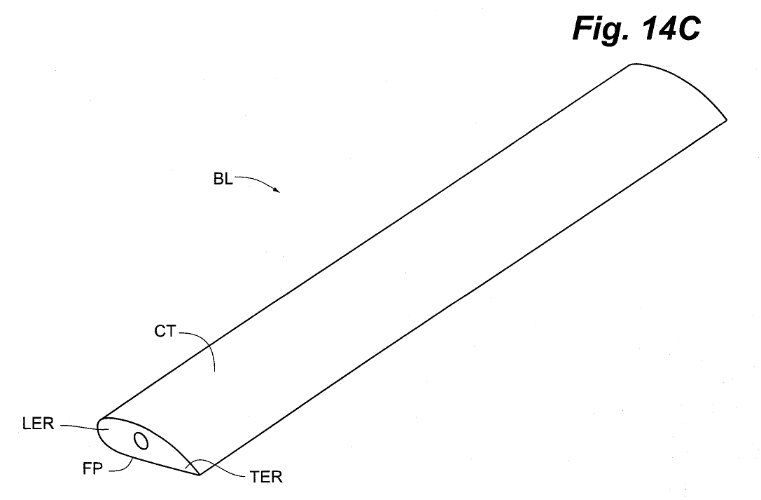

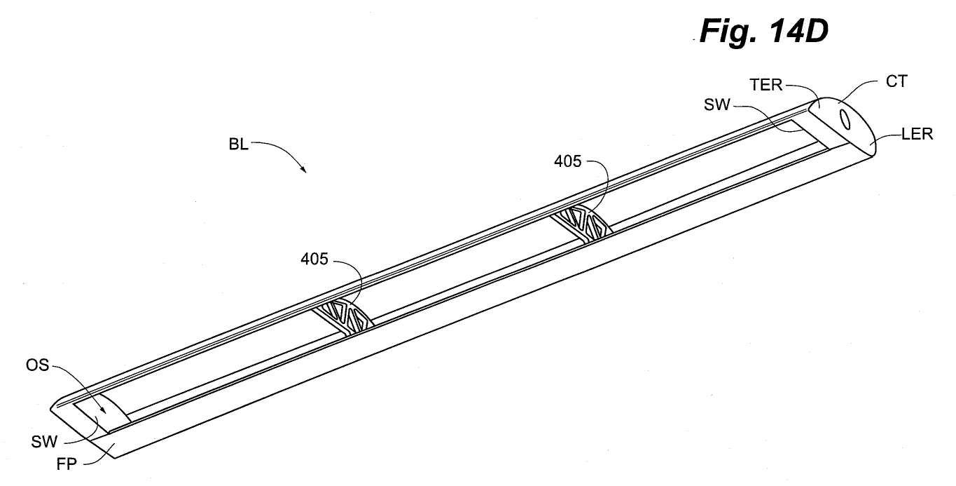

In some preferred embodiments, each blade BL has an open bottom section OS adjacent to the trailing end region TER of the blade BL. This is best seen in FIGS. 14A-14D. In other embodiments, only one of the blades has an open section, or only some of the blades have open sections. In still other embodiments, none of the blades have an open section. Instead, they have a closed-wing design.

The illustrated blade configuration is particularly advantageous. The open section of the blade, for example, assists with start-up. Due to the open blade configuration, the illustrated fan has a very low start-up speed; some embodiments of the fan assembly can start-up under winds of ½ mile per hour or less. Thus, the fan assembly can be used quite advantageously as an open-air fan, or in other low wind situations.

In FIGS. 14A-14D, the blade configuration has a leading end region LER, a trailing end region TER, and an open bottom section OS adjacent to the trailing end region. The open bottom section OS is adapted to create positive pressure (i.e., a pressure higher than the outside pressure) in an interior space of the blade BL during rotation of the fan assembly FA. More will be said of this later. Preferably, part of the interior space is inside the leading end region LER, as best seen in FIG. 14D. The open bottom section OS extends along substantially the entire span of the blade BL. And the interior space of the blade is closed on both ends of the span (e.g., by end walls SW), although this is not strictly required.

The illustrated blade configuration has a lift-generating bottom wall FP that extends from the leading end region LER toward the trailing end region TER and terminates at the open bottom section OS. This wall FP preferably is at least substantially planar, e.g., so as to have substantially no camber. The location and configuration of this wall FP helps generate lift early on as air flows around the blade. The wall FP preferably extends (from the leading end region toward the trailing end region) past (though just a bit past) the blade's aerodynamic lift center.

Referring to FIG. 1, the illustrated fan assembly FA includes two circular end plates EP between which the blades BL extend. Here, the end plates EP and the blades BL rotate together about the fan assembly's axis of rotation AX. Preferably, each blade BL has a cambered top wall CT extending between the leading end region LER and the trailing end region TER. In the illustrated embodiments, the cambered top wall CT has a radius at least substantially matching a radius of the circular end plates EP. This will be preferred in some cases. However, it is not a requirement. If desired, the camber on the top of the blade can be substantially different from the radius of the end plates. Moreover, the end plates are not strictly required to be circular; they can be provided in various shapes.

While the blade configuration shown in FIGS. 14A-14D is particularly advantageous, the fan assembly FA can employ many different types of blades. For example, the blade configuration need not be open; a variety of closed-wing configurations could be used.

In certain embodiments, the fan assembly FA is a horizontal fan. In such cases, the axis of rotation AX can be at least generally (or substantially) horizontal. However, this is not required. Rather, the axis of rotation can alternatively be vertical or inclined at various angles.

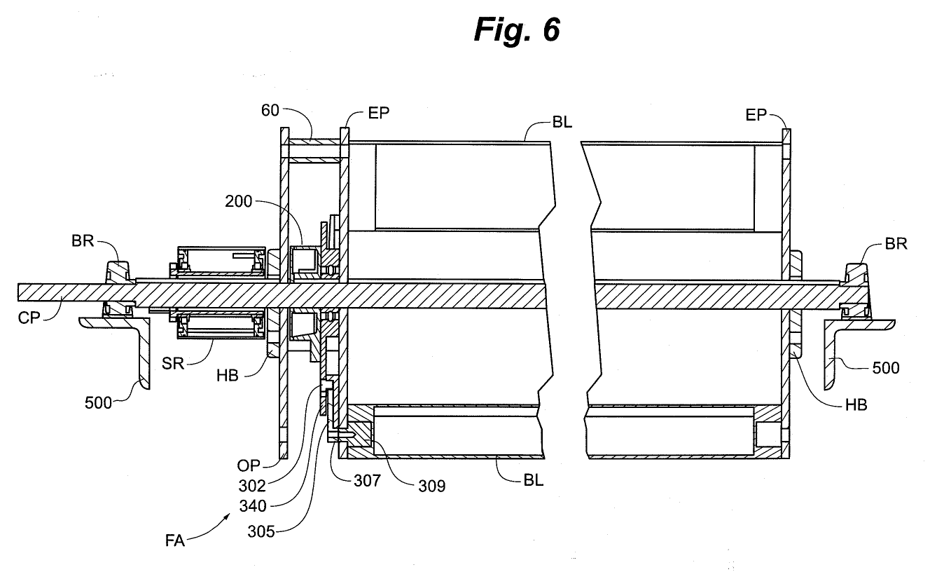

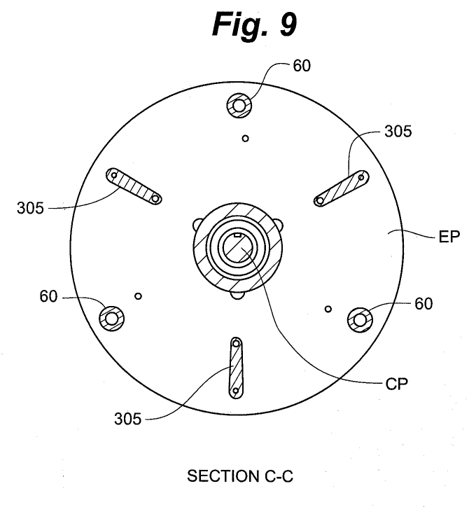

FIGS. 6-11 depict one exemplary embodiment of the fan assembly FA. Here, the fan assembly FA includes a center post CP that is rotatably mounted on bearings BR. The bearings can be any type of rotation bearings. In some embodiments, they are pillow blocks. One useful pillow block is the ConCentra ball bearing pillow block mount commercially available from SKF USA (Norristown, Pa., USA).

The illustrated fan assembly FA has three blades BL mounted between two end plates EP. The blades BL and end plates EP can be formed of different materials. In some embodiments, the blades and/or end plates are formed of an aircraft material. The aircraft material can be selected from the group consisting of aluminum, titanium, magnesium, beryllium, and alloys comprising one or more of these metals. Alternatively, they can be formed of steel, another metal, wood, or a polymer. If desired, the blades and/or end plates can be formed of a composite material. The composite material, for example, can comprise carbon fiber. One useful composite is a ceramic composite, such as a Kevlar ceramic composite. In preferred embodiments, the blades and end plates are formed of aluminum. In general, though, the material from which the blades and end plates are formed is not limiting to the invention.

In the exemplary blade construction shown in FIGS. 14A-14D, each blade BL has two support ribs (or “braces”) 405 spaced apart along the span of the blade. As just one example, the span of the blade BL can be 41 inches, the chord of the blade can be 7.02 inches, the chord of the blade's open section OS can be about 3.64 inches, the radius at the blade's leading end region LER can be 1 inch, the radius of the blade's cambered top section can be 7 inches, the radius at the blade's trailing end region TER can be 0.06 inch, the bottom wall FP can extend about an inch past the blade's aerodynamic lift center, the wall of the blade BL can be ⅛ inch aluminum sheet, and the ribs 405 can be ¼ inch aluminum sheet. These details, however, will change from design to design depending upon, for example, the size of the fan assembly and the requirements of a particular installation.

As just one example of how the blades and plates can be made, the mount plates EP, MP and end walls SW can be machined, the braces 405 can be lasered, and the skins can be formed in a press brake and welded to the end walls and braces.

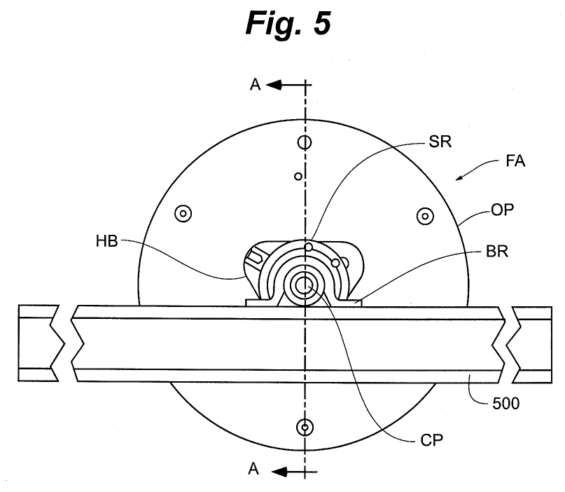

In FIG. 6, there is shown a cross-sectional view, taken along lines A-A of FIG. 5, of a mounted fan assembly FA. Here, the fan assembly FA is mounted between two supports 500. The center post CP of this fan assembly FA is mounted rotatably on two bearings BR, which are mounted respectively on the two supports 500. The manner of mounting the fan assembly, of course, will vary from case to case.

The illustrated fan assembly FA has an axis of rotation AX and includes blades BL and a motor 200. Preferably, each of a plurality of the blades BL has an angle of attack that is adjustable. In some cases, all the blades BL are adjustable, although this is not strictly required. The motor 200 is adapted to simultaneously adjust the angle of attack of all the blades BL of the plurality. In FIG. 1, the motor 200 simultaneously adjusts all the blades BL on the fan assembly FA; though, this is not required. Preferably, the fan assembly FA is configured such that the blades BL of the plurality all occupy substantially the same angle of attack during rotation of the fan assembly. In FIG. 1, all the blades BL on the fan assembly FA occupy the same angle of attack during rotation of the fan assembly. In such cases, the angle of attack may be changed for different phases of operation (e.g., one angle of attack may be used during a first phase of operation, such as start-up, while another angle of attack is used during a different phase of operation, such as a slow-down phase). Preferably, though, the blades BL are at the same angle of attack as one another at any given time. This can be seen, for example, in FIGS. 1, 8, and 13. In alternate embodiments, there could stages of operation when at least one blade is at a different angle of attack than at least one other blade. For example, to stop or slow the rotation of the fan assembly, one blade could be turned downwardly without adjusting the other blades. Many variants of this nature are possible.

Thus, the illustrated fan assembly FA is adapted to change the angle of attack of the blades BL. Preferably, the fan assembly (e.g., a motor 200 thereof) is adapted to change the orientation of the blades while the fan is rotating. This, however, is not required. For example, alternate embodiments involve a fan assembly where the blades are fixedly maintained at a set angle of attack.

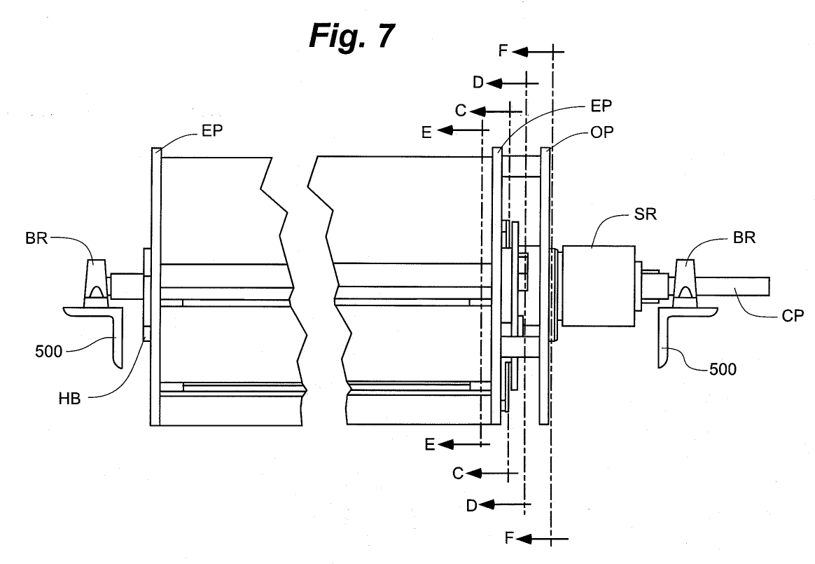

FIG. 7 is a broken-away front view of a fan assembly FA equipped with an exemplary blade-feathering sub-assembly. Here, the orientation of all the blades BL on the fan assembly FA can be adjusted simultaneously. This, however, is not strictly required; the orientations of the blades could alternatively be adjusted sequentially, or some blades could be adjustable while others are not.

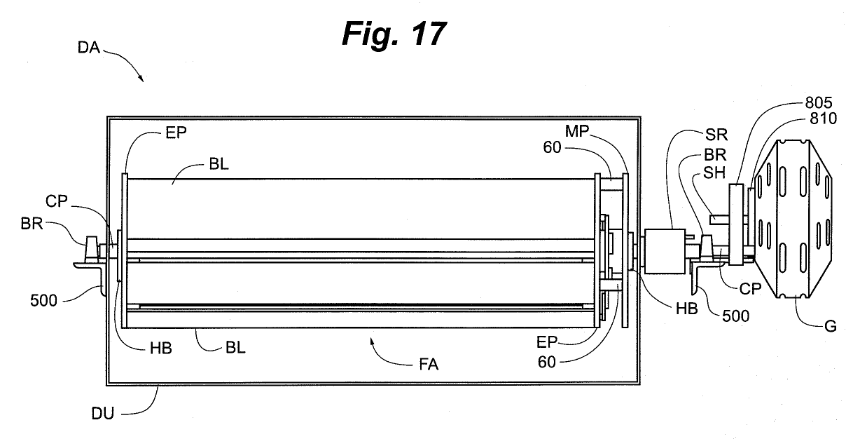

FIGS. 6-11 and 16-18 exemplify embodiments wherein the rotatable fan assembly FA includes (e.g., carries) a motor 200 adapted to change the orientation of the blades BL. During operation, the motor 200 rotates together with the fan assembly. The illustrated motor 200 is disposed about (e.g., surrounds) the fan assembly's center post CP, although this is by no means required. The motor 200 can optionally be a servo motor, and a slip ring SR can be used to deliver power to the motor.

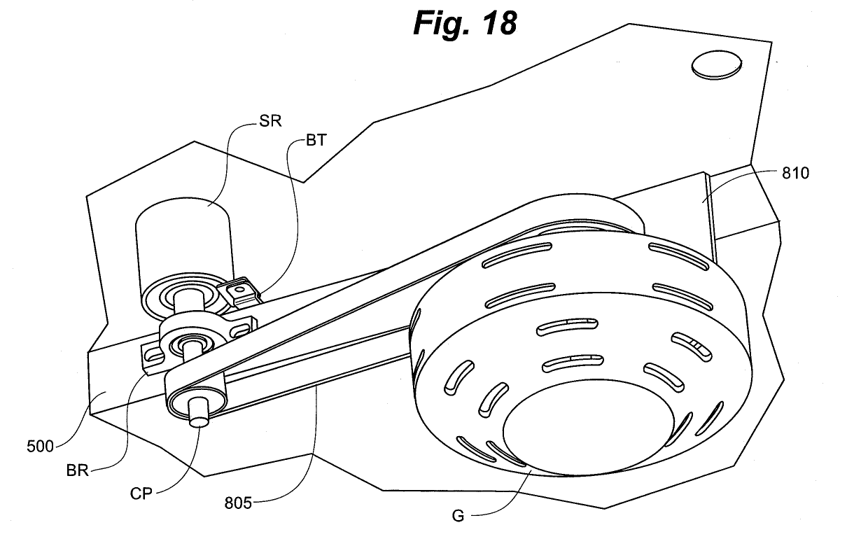

The illustrated fan assembly FA has a slip ring SR and an inner part of the slip ring is carried by the fan assembly so as to rotate together with the center post CP of the fan assembly, while an outer part of the slip ring is mounted in a fixed position, such that the inner part rotates relative to the outer part during rotation of the fan assembly. Reference is made to FIG. 18. Here, the outer part of the slip ring SR is mounted fixedly to the illustrated support 500 by a bracket BT, and the inner part of the slip ring rotates together with the center post CP. Many other arrangements, however, can be used to deliver power to the motor.

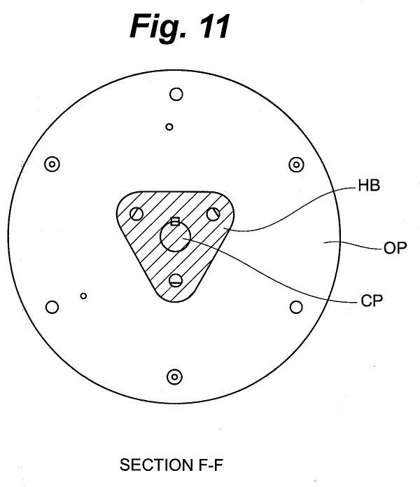

In certain embodiments, the motor 200 is disposed about (e.g., is carried on) a center post CP of the fan assembly FA. The illustrated fan assembly FA is centered around the center post CP. Thus, the center post CP extends between the end plates EP through the fan's central area, which is encompassed by the blades BL. In other embodiments, the fan assembly could alternatively have two posts projecting outwardly from the end plates on respective ends of the fan assembly (such that the center post does not pass through the fan's central area). In the illustrated embodiment, the center post CP passes through a central opening in each plate EP, MP and is fixed to those plates so as to rotate together with them, e.g., due to a keyed connection between a hub HB on each plate and the center post (as is best seen in FIG. 11).

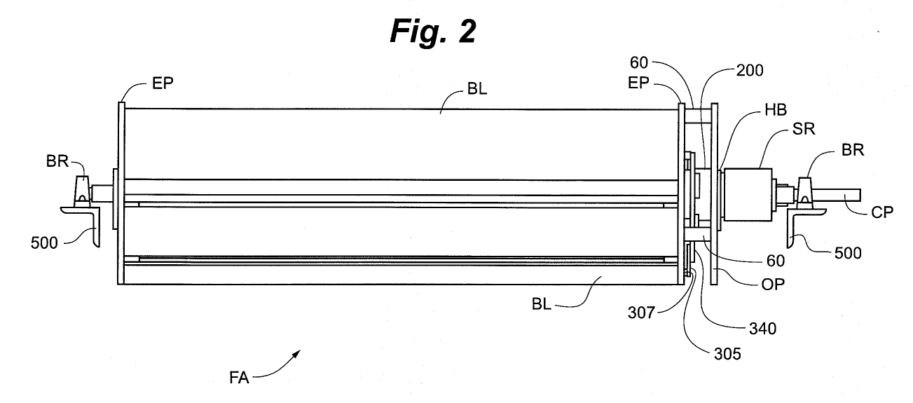

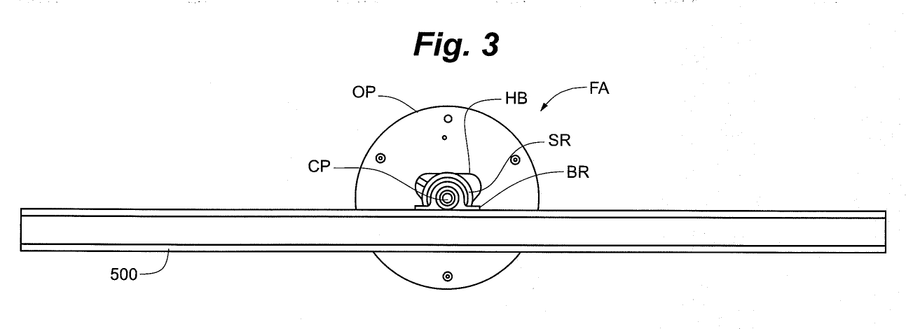

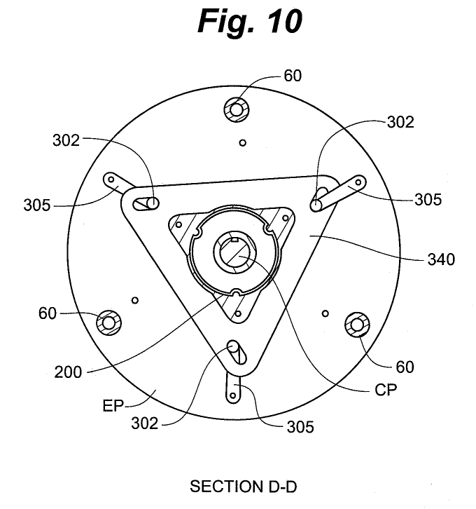

In the embodiments of FIGS. 6-11 and 16-18, a cam (e.g., a cam plate) 340 is operably coupled to the motor 200 such that the cam rotates (about the fan assembly's axis of rotation, relative to the end plate EP) in response to actuation of the motor. The illustrated motor 200 is a frameless motor (e.g., a hollow shaft servo motor), such as the EMOTEQ Frameless Motor (hollow shaft motor) HT03002 or HT03802. However, many different motor types can be used. The motor 200 can be actuated so as to rotate the cam 340, and this in turn causes pivoting of armatures 305 operably coupled to the blades BL. Referring to FIGS. 6 and 10, when the motor 200 is actuated, the cam 340 is made to rotate (either clockwise or counterclockwise, as seen in FIG. 10), and this causes the armatures 305 to pivot. As is perhaps best appreciated with reference to FIGS. 2, 6, and 10, each armature 305 is operably coupled to the cam 340 by means of a follower 302, and the armatures 305 are connected to respective blades BL by anchors 309 attached to the blades (see FIG. 6). Thus, the motor 200 can be operated so as to change the orientation (e.g., the angle of attack) of the blades BL. This, however, is merely one possible means for providing the fan assembly FA with a blade-feathering capability.

A simple control system can be used, such as a closed-loop motion control system (including a stand alone controller, an indexer, a motor, sensor, back to controller, etc.). Rpm data can be fed to the controller from a sensor, and the controller can send a command to the indexer and drive the motor and rotate the blades. For example, at zero rotations per minute (rpm), the blades can be wide open at 90 degrees; at an optimum speed range, the blades can be at 0 degrees. If for some reason there is a surge in the duct and the air speed exceeds the optimum range, then the motor can rotate the blades up to 270 degrees to correct the fan assembly speed as it approaches speeds outside the optimum rpm range. This is merely one example; the fan assembly can be controlled in various other ways.

As shown in FIG. 2, the fan assembly FA has an additional mount plate OP to facilitate the blade-feathering sub-assembly. Here, the outer mount plate OP is spaced apart from the adjacent end plate EP by a plurality of spacers 60. The outer mount plate OP can be formed of aluminum or another suitable material (see discussion above regarding end plates). The spacers 60 can be aluminum or any other suitable material. The spacers 60 can be secured releasably between the outer mount plate OP and the adjacent end plate EP, e.g., so as to facilitate easy assembly and disassembly. For example, releasable fasteners can be extended through openings in the plates EP, OP and anchored in the spacers 60. This, however, is merely one way to assemble the plates EP, OP.

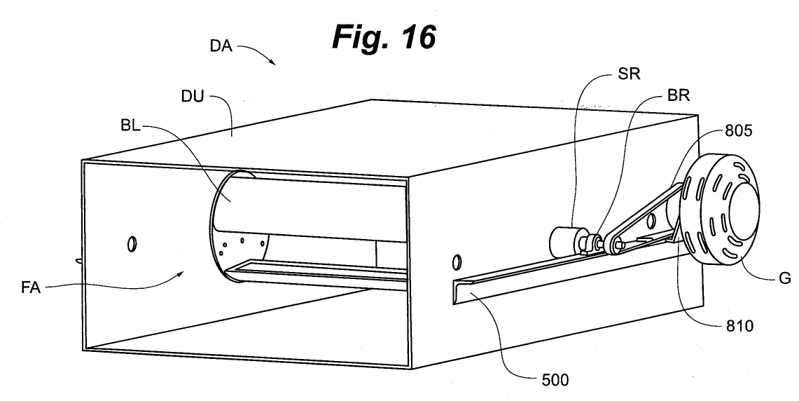

When operatively assembled, the fan assembly FA preferably is coupled with a power generator G adapted to generate electric power in response to rotation of the fan assembly. Reference is made to FIGS. 16-18. Here, the generator G is connected by a belt 805 to a center post CP of the illustrated fan assembly FA. Thus, when airflow rotates the fan assembly, the rotating center post CP of the fan assembly moves the belt 805, which in turn drives a shaft SH of the generator G. The illustrated generator G is mounted by a bracket 810 onto a support 500. However, the details of how the generator G is mounted and connected to the fan assembly FA are not limiting to the invention.

The invention also provides embodiments wherein the fan assembly has a wing-warping capability. In these embodiments, the motor on the fan assembly can be used to twist (or “warp”) the blades. Referring to FIG. 1, the blades BL can be attached fixedly to the end plate EP shown on the left, while the blades are attached pivotally (as described above) to the end plate EP shown on the right. Thus, when the motor is actuated so as to pivot one end of each blade, the blade is reversibly deformed in a twisting manner (since the opposite end of each blade is prevented from pivoting). In embodiments of this nature, the blades preferably are formed of a composite or another material that can reversibly endure the wing warping. A fan assembly with a wing-warping capability can be provided, for example, in applications where it is desirable to rotate the fan assembly at supersonic speeds. By holding the blades in a warped configuration as the fan assembly approaches the speed of sound, every point on the leading edge of a blade is at a different location. The blade is thereby designed to slice through the energy wave associated with breaking the sound barrier. Thus, some apparatus embodiments provide a fan assembly adapted for wing-warping, and some method embodiments involve maintaining the blades of such a fan assembly in warped configurations while rotating the fan assembly at speeds that approach, and eventually reach, the speed of sound. These methods will therefore involve the fan assembly breaking the sound barrier, thereby exceeding the speed of sound.

The invention also provides a method for generating electric power. The method involves providing a fan assembly FA that rotates in response to an airflow. The fan assembly used in the present method can be in accordance with any embodiment described above. In some cases, the fan assembly FA has blades BL that are at least generally parallel to an axis of rotation AX of the fan assembly, each of a plurality of the blades has an angle of attack that is adjustable, and the fan assembly includes a motor 200 adapted to simultaneously adjust the angle of attack of all the blades of the plurality. The fan assembly FA rotates in response to the airflow, and the blades BL of the plurality preferably occupy substantially the same angle of attack during rotation of the fan assembly. The fan assembly FA is operably coupled with a power generator G that generates electric power in response to the rotation of the fan assembly.

As already explained, the fan assembly preferably is non-restrictive, e.g., such that the speed of airflow immediately after the fan assembly is at least equal to the speed of airflow immediately before the fan assembly.

The fan assembly can be rotated at various speeds. In certain embodiments, the fan assembly rotates at 500-2,000 rpm, such as 650-1,500 rpm. The rotational speed, however, can vary considerably. For example, the rotational speed will vary depending upon the speed of the air incident upon the fan, the angle of attack of the blades, etc. Moreover, the particular generator used (and any gearing between the fan assembly and the generator) can impact the rotational speeds that may be used. Thus, the invention is not limited to any particular rpm range.

In the present method, the fan assembly FA can advantageously have an open blade configuration. As noted above, each blade BL can have a leading end region LER, a trailing end region TER, and an open bottom section OS adjacent to the trailing end region. In such cases, the open bottom section OS creates positive pressure in an interior space of the blade BL during rotation of the fan assembly FA. Part of this interior space preferably is inside the leading end region LER of the blade BL, such that part of the positive pressure region inside the blade is adjacent to the leading end region. Air flowing around the cambered top wall CT of the blade BL travels at an accelerated speed, thereby creating a low pressure (or “negative pressure”) region over the blade's top wall. Each blade preferably has a lift-generating bottom wall FP extending from the leading end region LER toward the trailing end region TER and terminating at the open bottom section OS. This wall FP preferably is at least substantially planar. During rotation of the fan assembly, this wall FP receives a lift force from the air flowing over it. Thus, positive pressure can be created inside the blade, as well as outside the blade at the lift-generating bottom wall FP, while negative pressure is created over the blade's cambered top wall. As a result, the blade has a low start-up speed and is able to travel through the air with ease.

In certain embodiments, the fan assembly FA includes two circular end plates EP between which the blades BL extend, and the end plates and blades rotate together about the fan assembly's axis of rotation. In some embodiments of this nature, each blade BL has a cambered top wall CT extending between the leading end region LER and the trailing end region TER, and this top wall has a radius at least substantially matching a radius of the circular end plates EP. This, however, is not required. For example, the camber of the blade's top wall can alternatively be quite different from the radius of the end pates. Moreover, the end plates are not required to be circular.

In some of the present method embodiments, the fan assembly FA is a horizontal fan, such that during rotation of the fan assembly the axis of rotation is at least generally horizontal. However, this is not required. Rather, the axis of rotation can alternatively be vertical or inclined at various angles.

In the present method, the fan assembly FA preferably includes a motor 200 adapted to change the angle of attack of all (or some) of the blades. And the method preferably involves operating the motor so as to adjust the angle of attack of all (or some) of the blades while the fan assembly is rotating.

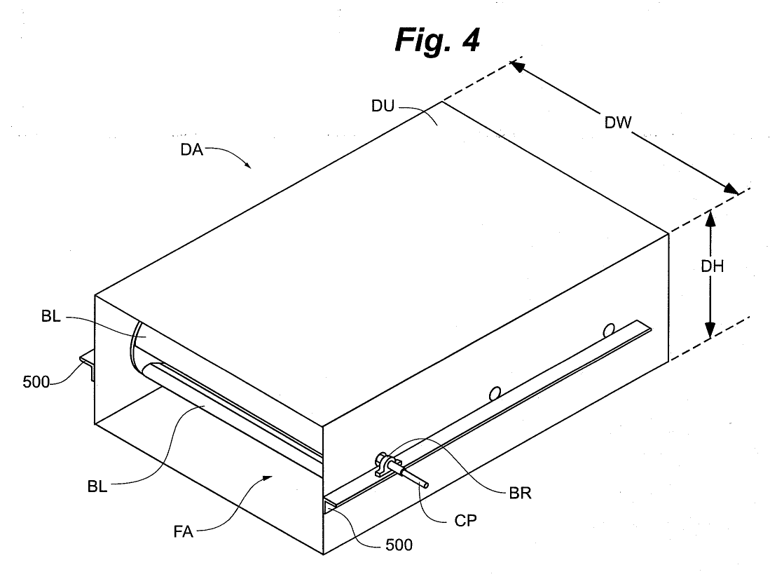

In one group of embodiments, the invention provides a duct assembly DA that includes a duct DU and a rotatable fan assembly FA. Reference is made to FIG. 4. Here, the fan assembly FA is mounted inside the duct DU so as to rotate in response to air moving through the duct. Thus, the fan assembly is adapted to rotate in the process of moving air (e.g., forced air) through the duct. In some cases, the air moving through the duct will have a positive pressure (i.e., a pressure greater than atmospheric pressure). However, this need not be the case in all embodiments.

As is perhaps best appreciated by referring to FIGS. 4, 13, and 15, the fan assembly preferably has an axis of rotation that is at least generally (or substantially) perpendicular to the direction of airflow WD in the duct. In some embodiments, the fan's axis of rotation is generally (or substantially) horizontal when operatively mounted. However, this is not strictly required. For example, the axis of rotation can alternatively be vertical or inclined at various angles, e.g., depending upon the orientation of the duct and the available space around the duct (which may dictate how the fan is mounted).

In the illustrated embodiments, the fan assembly is mounted such that its blades BL are entirely within the duct. While this will commonly be preferred, alternative embodiments involve arrangements where the blades of the fan assembly are longer than the duct width DW, e.g., such that only part of the fan is in the stream of airflow. The duct, for example, can have two openings in its sidewalls, and the fan can be mounted in those openings such that only a central length of the fan is in the airflow (in such cases, both end regions of the fan may be outside the duct). Thus, the manner of mounting the fan can be varied so long as the stream of air flowing through the duct causes the fan to rotate.

FIG. 4 shows a single fan assembly FA mounted rotatably inside the duct DU. Alternatively, two or more fan assemblies can be mounted in series within a duct. In FIG. 4, the illustrated duct DU is adapted to receive two additional fan assemblies. Thus, the duct DU can optionally be equipped with a series of rotatable fan assemblies. Also, various staggered or stacked arrangements can be used for positioning a plurality of fan assemblies inside a duct. Many variants of this nature are anticipated.

In embodiments like those of FIG. 4, the fan assembly FA has a generally cylindrical configuration, and the duct DU in which the fan assembly is mounted has a generally rectangular cross-sectional configuration (the illustrated duct is a rectangular duct). In embodiments of this nature, the cylindrical configuration of the fan assembly FA preferably is elongated along an axis that is at least substantially parallel to an axis along which the rectangular cross-sectional configuration of the duct DU is elongated. In such cases, the fan assembly can be configured to match the configuration of the duct. In some embodiments, the length of the fan assembly's blades BL is at least 75% as great as the width DW of the duct DU. Additionally or alternatively, the diameter of the fan assembly FA can be at least 75% as great as the height DH of the duct DU. This dimensioning, however, is by no means limiting to the invention.

The duct DU shown in FIG. 4 is rectangular. However, the duct can alternatively have a round cross-sectional configuration, or any other configuration. Regardless of the duct shape, it may be preferred for the length of the blades to be at least 75% as great as a width DW or diameter of the duct.

In embodiments like that of FIG. 4, the fan assembly FA is mounted in a section of ductwork that is fairly conventional (other than having supports 500, and openings in the duct sidewalls to receive the center post CP of the fan assembly). Thus, the fan assembly FA can be readily mounted in a conventional duct. As a result, it is easy to retrofit existing ducts with fan assemblies, or to design fan assemblies into new construction. If desired, the fan assembly can be mounted in a special duct designed to house the fan assembly. In such cases, this section of special duct may be connected to one end of an expanse of conventional ductwork, or it may be positioned between two expanses of conventional ductwork. The special duct may have a greater width (to accommodate the fan's width), and transitions may be required where the special duct is connected to conventional ductwork, to a blower, etc. Further, a special housing structure may be built to accommodate the fan, and this housing may serve as the duct. The special housing may support not only the fan assembly and the walls defining the airway, but also a generator and/or other special equipment or structures associated with the fan assembly.

In the present duct assembly DA, a rotation shaft preferably protrudes outwardly from the duct DU. When provided, the rotation shaft can advantageously be adapted for being operably coupled with a generator. The generator is adapted to create electric power in response to rotation of the shaft. Thus, in the present duct assembly DA, there preferably is at least one rotation shaft extending externally from the duct (part of the shaft may be inside the duct, while one or both end regions of the shaft protrude outside the duct), and the shaft preferably is configured to be connected to a suitable power generator.

In the embodiment of FIG. 4, the rotation shaft is a center post CP of the fan assembly FA. Here, the center post CP lies on the fan assembly's axis of rotation. The center post CP rotates when the fan assembly FA rotates. And the center post CP is adapted for connection to a generator that creates electric power in response to rotation of the center post. In some cases, this is accomplished by coupling the center post to a generator such that rotation of the center post causes a shaft of the generator to rotate, thereby creating electric power. Reference is made to FIGS. 16-18, which have already been described.

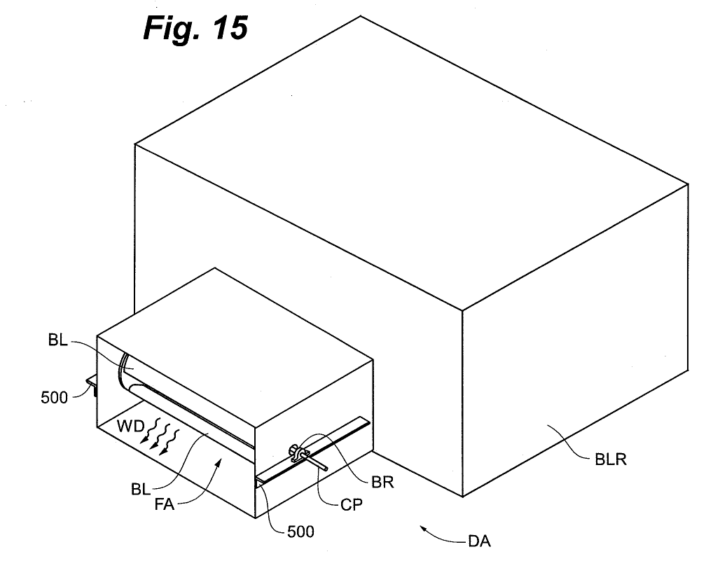

In some preferred embodiments, the invention provides an HVAC duct assembly that includes a duct, a rotatable fan assembly, and a blower. The blower can be any device that pushes or pulls air through the duct. Thus, the blower can be upstream or downstream from the fan assembly. Reference is made to FIG. 15. The duct DU and the fan assembly FA have already been described. The blower BL is adapted to move air through the duct DU and past the fan assembly, e.g., so as to rotate the fan assembly in the process of moving air through the duct.

In certain embodiments, the blower BL is upstream from the fan assembly FA. The fan assembly FA, for example, can be located less than 100 feet downstream from the blower BL (such as less than 50 feet downstream from the blower, less than 25 feet downstream from the blower, or less than 15 feet downstream from the blower). These ranges, however, are not strictly required.

In some embodiments, the fan assembly F is adjacent to the blower BL. In some cases, the adjacent blower is upstream from the fan assembly, but in other cases the blower is downstream from the adjacent fan assembly.

In some of the present embodiments, the blower BL is adapted to accelerate air to a speed of at least 1,000 feet per minute, and in many cases at least 3,000 feet per minute. In certain preferred embodiments, the blower BL is a high-performance blower adapted to accelerate air to a speed of at least 5,000 feet per minute. Blowers of this nature may be particularly well suited for being coupled with the present power-generator fan assembly. However, there is no strict limitation on the minimum blower size that can be used.

Generally, the blower BL can be of any type that meets the requirements of a given HVAC system. For example, the blower can be a conventional axial fan or centrifugal air handling fan. Other blower types can also be used. A variety of useful blowers are commercially available from Delhi Industries (Delhi, Ontario, Canada), Loren Cook Co. (Springfield, Mo., USA), and New York Blower (Willowbrook, Ill., USA). One exemplary blower is the Delhi Plenum Fan model No. VPL36.

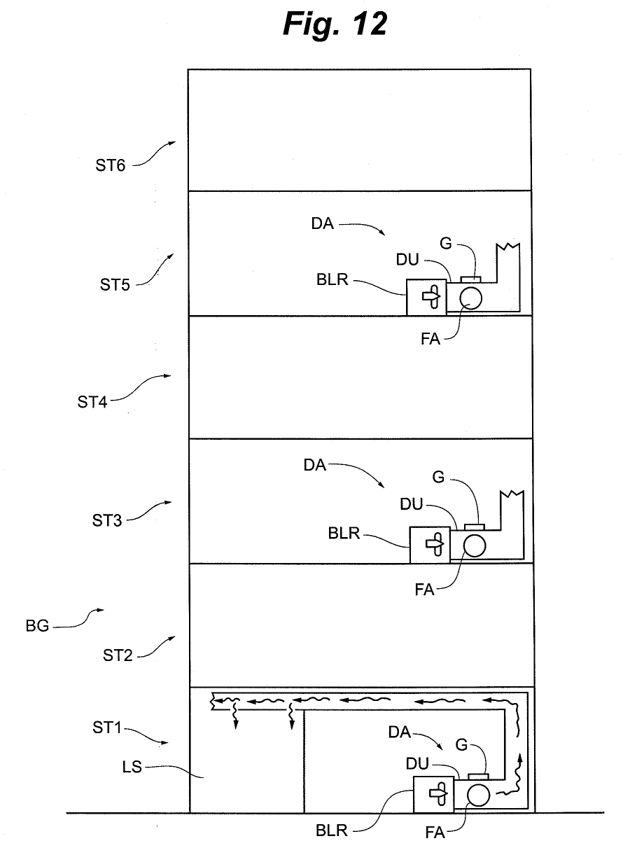

In the present embodiments, the HVAC duct assembly preferably is adapted to move air past the fan assembly FA and then on to be distributed inside a building, optionally into a living space of the building. The living space, for example, can be an office, a meeting room, hallway, bedroom, kitchen, or bathroom, to name just a few. Reference is made to FIG. 12, which shows a duct assembly DA with a blower BL that moves air past a fan assembly FA and then into a living space LS of a building BG (see the first story ST1 of the illustrated building). The arrangement of FIG. 12 is schematic. However, it exemplifies embodiments wherein, after air from the blower BL flows past the fan assembly FA, the air continues on to be distributed inside the building (rather than being discharged outside the building immediately after passing the fan assembly).

Thus, the fan assembly FA is provided in the duct DU to harness energy from the air flow inside the duct. And therefore the fan assembly F is coupled to a power generator G adapted to produce electric power in response to rotation of the fan assembly. The generator G can be of a variety of commercially available types. As just one example, it can be a generator from Raven Technologies (Brunswick, Me., USA), such as the Blackbird 5 kW 120VAC-60 Hz generator. This generator can produce 5,000 watts at 3,100 rpm, and it can operate efficiently from 3,100 to 10,000 rpm. As just one practical example, if the fan assembly rotates at 650-1,500 rpm, and the assembly is geared up 1:5, then the generator will run at 3,250-7,500 rpm. These details, however, are not limiting to the invention.

As noted above, the illustrated fan assembly FA has a center post CP lying on the fan assembly's axis of rotation. Here, the center post CP rotates when the fan assembly FA rotates, and the generator G creates electric power in response to rotation of the post CP. The generator G, for example, can be designed to use a belt drive system (such as a six groove K-Series belt). This can be accomplished by coupling the center post CP to a shaft SH of the generator G such that rotation of the center post moves a belt 805, which in turn drives the shaft SH of the generator G. This type of connection between the fan assembly FA and the generator G is merely exemplary; many other arrangements can be used.

In one group of embodiments, the invention provides a building BG that includes at least one duct DU in which a fan assembly FA is mounted. The building can be of any type that has ducts for heating, ventilation, and/or air conditioning. In some embodiments, the building is a multiple-story building, such as a high-rise or another tower-like building. However, this is not required. Rather, other types of buildings can be used.

As noted above, the fan assembly FA is provided in the duct DU to harness energy from air flowing through the duct. The airflows inside the ducts of buildings commonly move at very high speeds. Thus, a fan assembly F mounted inside a duct DU of a building's HVAC system can be advantageously coupled to a power generator G. And the generator can be adapted to produce electric power in response to rotation of the fan assembly. The power harvested can be used to service the building, sold back to the power company, or both.

In the present embodiments, the building BG has an HVAC system that includes a blower BL adapted to move air through a duct DU of the HVAC system. Again, the blower can be any device or system that pushes or pulls air through the duct. The fan assembly FA in the duct DU is located such that air moved by the blower BL flows past the fan assembly FA, thereby causing the fan assembly to rotate. After flowing past the fan assembly, the air continues on to be distributed inside the building. In some embodiments, the fan assembly is located such that air moved by the blower BL flows past the fan assembly FA and then into a living space LS of the building BG. The living space can be an office, a meeting room, hallway, bedroom, kitchen, bathroom, etc.

In some of the present embodiments, the fan assembly FA is mounted inside a non-vertical (e.g., generally horizontal) expanse of duct DU. FIG. 12 exemplifies embodiments of this nature. However, this is by no means required. For example, other embodiments provide a fan assembly mounted in a vertical expanse of duct. Still other embodiments provide the fan in an inclined expanse of duct. Moreover, a given building could have some fan assemblies in horizontal ducts, while others are in vertical or inclined ducts. Numerous variants of this nature are possible.

As noted above, FIG. 12 shows a blower BL that moves air past a fan assembly FA and then into a living space LS of a building BG (see the first story ST1 of the illustrated building). While the arrangement of FIG. 12 is schematic, it exemplifies embodiments where, after air from the blower BL flows past the fan assembly FA, the air continues on to be distributed inside the building.

Thus, in some embodiments, the fan assembly FA in the duct DU is located downstream from the blower BL. In other embodiments, though, the fan assembly is upstream from the blower. In some cases, the fan assembly FA is adjacent to the blower B. If desired, the fan assembly FA can be located within a certain distance from the blower BL (reference is made to the ranges given above). The fan's distance from the blower, however, will vary for different applications.

In some of the present embodiments, a fan assembly FA in the building BG is located to receive air traveling through a duct DU at a speed of at least 1,000 feet per minute. This is not to say that the fan requires such fast air speeds to start-up and operate; it merely indicates that when the fan is mounted in certain ducts, the fan will receive an airflow moving at such a speed. In some cases, the blower BL is adapted to accelerate air to a speed of at least 3,000 feet per minute. Certain preferred embodiments provide a high-performance blower that is adapted to accelerate air to a speed of at least 5,000-6,000 feet per minute.

In some of the present embodiments, the building BG has multiple stories. Reference is made to FIG. 12. Here, the building is provided with a plurality of blowers BL and a plurality of power-generator fan assemblies FA mounted inside respective ducts DU of the building's HVAC system. In embodiments like FIG. 12, the blowers BL and fan assemblies FA are not provided on every story. Thus, between two stories equipped with blowers and fan assemblies, there is at least one story that does not have a power-generator fan assembly driven by a blower. As just one example, a separate blower could be provided to service each block of two adjacent stories, as shown in FIG. 12 (where the blower on story 1 services both the first and second stories, etc.). And each of these blowers may be coupled with at least one power-generator fan assembly. As other alternatives, there may be a separate blower for each story, or multiple blowers may be provided on each story, or each blower may service a block of three stories, etc.

In connection with using the fan assembly on buildings, the fan and duct assemblies of the invention can be used in new construction, or they can be incorporated into existing buildings on a retro-fit basis. Thus, the present fan assemblies can be deployed in buildings with great flexibility.

The invention also provides methods for heating, ventilating, and/or air conditioning a building. These methods involve providing a duct assembly DA that includes a blower BL, a duct DU, and a rotatable fan assembly FA. The fan assembly FA is mounted inside the duct DU, and the blower BL is operated so as to move air past the fan assembly, thereby rotating the fan assembly, and then on to be distributed inside the building BG. As noted above, the fan assembly FA is coupled to a power generator G, such that the generator produces electric power in response to rotation of the fan assembly. Thus, the present methods involve operating a blower BL of an HVAC system so as to move (e.g., push or pull) air through a duct DU in which there is mounted a rotatable fan assembly FA, which is thereby caused to rotate so as to drive a generator G that produces electric power.

Thus, the generator G produces power in response to rotation of the fan assembly FA. As noted above, the illustrated fan assembly FA includes a center post CP that rotates when the fan assembly rotates, and the generator G creates electric power in response to rotation of the fan assembly's center post.

In some of the present methods, the air moved by the blower BL flows past the fan assembly FA and then continues on inside the building. In some cases, the air is then delivered into a living space LS of the building BG. In such cases, the air delivered into the living space may be relatively cool air delivered to air condition (i.e., to cool) the living space, or it may be relatively warm air delivered to heat the living space, and/or the air may be delivered to ventilate the living space. The present methods may involve delivering air (which has already flowed past the fan assembly) into an interior space (optionally a living space) of the building through one or more outlet vents.

In some of the present methods, the fan assembly FA in the duct DU receives air traveling at a speed of at least 1,000 feet per minute. Again, this is not to say the fan requires such high air speeds to start-up and operate; rather, it merely indicates that the fan is mounted inside a duct at a position that receives an airflow traveling at such a speed. Further, the blower in some cases accelerates air to a speed of at least 3,000 feet per minute, or at least 5,000 feet per minute (in the case of a high-performance blower). Smaller blowers, though, can also be used.

The fan assembly FA has a plurality of blades BL, and in certain methods of operation, the blades are held at different angles fat different stages of operation. The blades BL, for example, can be held at one angle during a start-up stage, and then moved to a different angle during normal operation. It may also be desirable to change the angle of attack when the fan's rotation speed is either higher or lower than desired. For example, the generator will commonly have a certain rpm range in which it operates efficiently, so the rotational speed of the fan assembly may be controlled so as to keep the generator operating within its range of efficiency.

In some embodiments, each blade BL of the fan assembly FA has an open section OS (e.g., adjacent to the blade's trailing end region), as already explained. In such cases, a positive pressure preferably is established inside the blade during rotation of the fan assembly. And because part of the blade's open interior space is inside the blade's leading end region, part of the positive pressure region inside the blade is adjacent to the leading edge region. The benefits of this arrangement has already been described.

As noted above, the illustrated fan assembly FA has two end plates EP between which the blades BL extend. During use, the blades and the end plates of the illustrated fan assembly rotate together about the fan assembly's axis of rotation. And the center post of the illustrated fan assembly rotates as well. The illustrated motor also rotates. In other embodiments, though, one or more of these components (e.g., the end plates) may be omitted entirely, or may be present but configured to remain stationary while other parts of the fan assembly rotate.

While certain preferred embodiments of the invention have been described, it should be understood that various changes, adaptations and modifications can be made without departing from the spirit of the invention and the scope of the appended claims.

What is claimed is:

1. A building having an HVAC system comprising a blower adapted to move air through a duct of the HVAC system, the building having a rotatable fan assembly mounted inside the duct, the fan assembly being located such that air moved by the blower flows past the fan assembly, thereby rotating the fan assembly, and then continues on to be distributed inside the building, the fan assembly being operably coupled with a power generator adapted to generate electric power in response to rotation of the fan assembly.

2. The building of claim 1 wherein the fan assembly is located such that air moved by the blower flows past the fan assembly and then into a living space of the building.

3. The building of claim 1 wherein the fan assembly is non-restrictive such that a speed of the air immediately after the fan assembly is at least equal to a speed of the air immediately before the fan assembly.

4. The building of claim 1 wherein the fan assembly is in the duct at a location adjacent to the blower.

5. The building of claim 1 wherein the fan assembly is in the duct at a location that receives air traveling at a speed of at least 1,000 feet per minute.

6. The building of claim 1 wherein the fan assembly is mounted in a generally horizontal expanse of duct.

7. The building of claim 1 wherein the blower is adapted to accelerate air to a speed of at least 3,000 feet per minute.

8. The building of claim 1 wherein the building has multiple stories, and wherein the building has a plurality of blowers and a plurality of rotatable power-generator fan assemblies mounted inside respective ducts of the HVAC system, wherein the blowers and fan assemblies are not provided on every story such that between two stories equipped with the blowers and fan assemblies there is at least story that does not have a power-generator fan assembly driven by a blower.

9. The building of claim 1 wherein the fan assembly has a plurality of blades each having a span that is at least 75% as great as a width or diameter of the duct.

10. The building of claim 1 wherein the fan assembly has a generally cylindrical configuration, the duct has a generally rectangular configuration, and the cylindrical configuration of the fan assembly is elongated along an axis that is at least substantially parallel to an axis along which the rectangular configuration of the duct is elongated, such that the fan assembly is configured to match the configuration of the duct.

11. The building of claim 1 wherein the fan assembly has a plurality of blades, the blades being at least substantially parallel to an axis of rotation of the fan assembly.

12. The building of claim 11 wherein each blade has a leading end region and a trailing end region, each blade having an open bottom section adjacent to the trailing end region, the open bottom section being adapted to create a positive pressure in an interior space of the blade during rotation of the fan assembly.

13. The building of claim 11 wherein the fan assembly is adapted to change the angle of attack of the blades while the fan assembly is rotating.

14. The building of claim 11 wherein the fan assembly includes a motor adapted to change the angle of attack of the blades, and the motor is carried by the fan assembly so as to rotate together with the fan assembly.

15. The building of claim 1 wherein the fan assembly includes a center post lying on an axis of rotation of the fan assembly, wherein the center post rotates when the fan assembly rotates, and the power generator creates electric power in response to rotation of the fan assembly's center post.

16. An HVAC duct assembly comprising a blower, a duct, and a rotatable fan assembly, the rotatable fan assembly being mounted inside the duct, the blower being adapted to move air through the duct and past the fan assembly so as to rotate the fan assembly in the process of moving air through the duct.

17. The HVAC duct assembly of claim 16 wherein the fan assembly is non-restrictive such that a speed of the air immediately after the fan assembly is at least equal to a speed of the air immediately before the fan assembly.

18. The HVAC duct assembly of claim 16 wherein the blower in the duct assembly is a high-performance blower adapted to accelerate air to a speed of at least 5,000 feet per minute.

19. The HVAC duct assembly of claim 16 wherein the fan assembly is in the duct at a location adjacent to the blower.

20. The HVAC duct assembly of claim 16 wherein the fan assembly is in the duct at a location that receives air traveling at a speed of at least 1,000 feet per minute.

21. The HVAC duct assembly of claim 16 wherein the fan assembly has a plurality of blades each having a span that is at least 75% as great as a width or diameter of the duct.

22. The HVAC duct assembly of claim 16 wherein the fan assembly has a generally cylindrical configuration, the duct has a generally rectangular configuration, and the cylindrical configuration of the fan assembly is elongated along an axis that is at least substantially parallel to an axis along which the rectangular configuration of the duct is elongated, such that the fan assembly is configured to match the configuration of the duct.

23. The HVAC duct assembly of claim 16 wherein the duct assembly is adapted to deliver the air, after it has moved past the fan assembly, into a living space of a building.

24. The HVAC duct assembly of claim 16 wherein the fan assembly is mounted in a generally horizontal expanse of duct.

25. The HVAC duct assembly of claim 16 wherein the fan assembly comprises a plurality of blades, the blades being at least substantially parallel to an axis of rotation of the fan assembly.

26. The HVAC duct assembly of claim 25 wherein each blade has a leading end region and a trailing end region, each blade having an open bottom section adjacent to the trailing end region, the open bottom section being adapted to create a positive pressure in an interior space of the blade during rotation of the fan assembly.

27. The HVAC duct assembly of claim 25 wherein the fan assembly is adapted to change the angle of attack of the blades while the fan assembly is rotating.

28. The HVAC duct assembly of claim 25 wherein the fan assembly includes a motor adapted to change the angle of attack of the blades, and the motor is carried by the fan assembly so as to rotate together with the fan assembly.

29. The HVAC duct assembly of claim 16 wherein the duct assembly comprises a power generator operably coupled with the fan assembly, the generator being adapted to produce electric power in response to rotation of the fan assembly.

30. The HVAC duct assembly of claim 29 wherein the fan assembly includes a center post lying on an axis of rotation of the fan assembly, wherein the center post rotates when the fan assembly rotates, and wherein the power generator creates electric power in response to rotation of the fan assembly's center post.

31. A method for heating, ventilating, and/or air conditioning a building, the method comprising providing a duct assembly including a blower, a duct, and a rotatable fan assembly, the rotatable fan assembly being mounted inside the duct, the blower being operated so as to move air past the fan assembly, thereby rotating the fan assembly, and then on to be distributed inside the building, the fan assembly being operably coupled with a power generator such that the generator produces electric power in response to rotation of the fan assembly.

32. The method of claim 31 wherein the air moved by the blower flows past the fan assembly and then into a living space of the building.

33. The method of claim 31 wherein the fan assembly is non-restrictive such that a speed of the air immediately after the fan assembly is at least equal to a speed of the air immediately before the fan assembly.

34. The method of claim 31 wherein the fan assembly is in the duct at a location that receives air traveling at a speed of at least 1,000 feet per minute.

35. The method of claim 31 wherein the blower accelerates air to a speed of at least 3,000 feet per minute.

36. The method of claim 31 wherein the fan assembly comprises two end plates between which extend a plurality of blades, the blades being at least substantially parallel to an axis of rotation for the fan assembly, and wherein the end plates and the blades rotate together about the fan assembly's axis of rotation.

37. The method of claim 36 wherein each blade has a leading end region and a trailing end region, each blade having an open bottom section adjacent to the trailing end region, the open bottom section creating a positive pressure in an interior space of the blade during rotation of the fan assembly.

38. The method of claim 36 wherein the method involves maintaining all the blades at a first angle of attack during a first stage of operation, and maintaining all the blades at a second angle of attack during a second stage of operation, the first and second angles of attack being different.

39. The method of claim 31 wherein the fan assembly includes a center post lying on an axis of rotation of the fan assembly, wherein the center post rotates when the fan assembly rotates, and the power generator creates electric power in response to the rotation of the fan assembly's center post.

40. A fan assembly adapted to rotate in response to an airflow, the fan assembly having blades that are at least generally parallel to an axis of rotation of the fan assembly, wherein each of a plurality of the blades has an angle of attack that is adjustable, the fan assembly including a motor adapted to simultaneously adjust the angle of attack of all the blades of said plurality, the fan assembly being configured such that the blades of said plurality all occupy substantially the same angle of attack during rotation of the fan assembly, the fan assembly being operably coupled with a power generator adapted to generate electric power in response to rotation of the fan assembly.

41. The fan assembly of claim 40 wherein each blade has a leading end region and a trailing end region, at least one of the blades has an open bottom section adjacent to the trailing end region, and the open bottom section is adapted to create a positive pressure in an interior space of the blade during rotation of the fan assembly.

42. The fan assembly of claim 41 wherein part of the interior space is inside the leading end region of the blade.

43. The fan assembly of claim 41 wherein a lift-generating bottom wall extends from the leading end region toward the trailing end region and terminates at the open bottom section, the lift-generating bottom wall being at least substantially planar.

44. The fan assembly of claim 41 wherein the open bottom section extends along at least substantially an entire span of the blade.

45. The fan assembly of claim 44 wherein the interior space is closed on both ends of the span.

46. The fan assembly of claim 40 wherein the fan assembly comprises two circular end plates between which the blades extend, wherein the end plates and the blades rotate together about the fan assembly's axis of rotation, each blade having a curved top wall extending between the leading end region and the trailing end region, the curved top wall having a radius at least substantially matching a radius of the circular end plates.

47. The fan assembly of claim 40 wherein the fan assembly is a horizontal fan, the axis of rotation being at least generally horizontal.

48. The fan assembly of claim 40 wherein the motor is adapted to adjust the angle of attack of all the blades of said plurality while the fan assembly is rotating.

49. The fan assembly of claim 40 wherein the motor is disposed about a center post of the fan assembly.

50. The fan assembly of claim 40 wherein the motor is carried by the fan assembly so as to rotate together with the fan assembly.

51. The fan assembly of claim 40 wherein the fan assembly is non-restrictive such that a speed of the airflow immediately after the fan assembly is at least equal to a speed of the airflow immediately before the fan assembly.

52. A method of generating electric power, wherein the method comprises providing a fan assembly that rotates in response to an airflow, the fan assembly having blades that are at least generally parallel to an axis of rotation of the fan assembly, wherein each of a plurality of the blades has an angle of attack that is adjustable, the fan assembly including a motor adapted to simultaneously adjust the angle of attack of all the blades of said plurality, wherein the method involves the fan assembly rotating in response to the airflow such that the blades of said plurality all occupy substantially the same angle of attack during said rotation of the fan assembly, the fan assembly being operably coupled with a power generator that generates electric power in response to said rotation of the fan assembly.

53. The method of claim 52 wherein the fan assembly is non-restrictive such that a speed of the airflow immediately after the fan assembly is at least equal to a speed of the airflow immediately before the fan assembly.

54. The method of claim 52 wherein each blade has a leading end region, a trailing end region, and an open bottom section adjacent to the trailing end region, the open bottom section creating a positive pressure in an interior space of the blade during said rotation of the fan assembly.

55. The method of claim 54 wherein each blade has a lift-generating bottom wall extending from the leading end region toward the trailing end region and terminating at the open bottom section, the lift-generating wall being at least substantially planar, wherein during rotation of the fan assembly the lift-generating wall receives a lift force from air flowing over that wall.

56. The method of claim 54 wherein part of the interior space is inside the leading end region, such that part of a positive pressure region inside the blade is adjacent to the leading end region.

57. The method of claim 52 wherein the fan assembly includes two circular end plates between which the blades extend, wherein the end plates and the blades rotate together about the fan assembly's axis of rotation, and each blade has a curved top wall extending between the leading end region and the trailing end region, the curved top wall having a radius at least substantially matching a radius of the circular end plates.

58. The method of claim 52 wherein the fan assembly is a horizontal fan, such that during said rotation of the fan assembly the axis of rotation is at least generally horizontal.

59. The method of claim 52 wherein the method includes operating the motor so to simultaneously adjust the angle of attack of all the blades of said plurality while the fan assembly is rotating.

60. The method of claim 52 wherein the fan assembly rotates at between 500 and 2,000 rotations per minute.
